(19) United States
(12) Patent Application Publication
(10) Pub. No.: US 2011/0037205 A1
(43) Pub. Date: Feb. 17, 2011

(54) FOAM COSTUMES

(76) Inventors: Peter A. Russo, Bedford, MA (US); Cheuk-Tat Liu, Kowloon Tong (HK)

Correspondence Address: GAUTHIER & CONNORS, LLP, 225 FRANKLIN STREET, SUITE 2300, BOSTON, MA, 02110, US

(21) Appl. No.: 12/542,176

(22) Filed: Aug. 17, 2009

(51) Int. Cl. B29C 51/10; B29C 51/20; B29C 51/36

(52) U.S. Cl. 264/545; 425/538

(57) ABSTRACT

A three dimensional foam costume molded from a vacuum molding or thermoforming machine which simultaneously molds two sheets of plastic. The machine is comprised of two female concave molds which are positioned one over the other and an opening mechanism to open and close the two molds. The machine accepts two sheets of plastic at one time and air is provided between the two sheets to force each sheet of plastic into one of the molds to form a three-dimensional costume in which the edges of the costume are sealed.

### BACKGROUND OF THE INVENTION

Costumes, especially Halloween costumes have become a huge industry. There are many different types of costumes in the market. Some people are rather creative and can put together a costume together from things that they have around the house, including a simple eye patch for a pirates costume or a sheet to become a ghost.

In the past, Halloween costumes consisted of pajamas, simple nylon character outfits that one would simply put on over their clothing or dresses of ones' favorite princess.

There are also patents directed to movable 3-dimensional items such as wings as shown in U.S. Pat. No. 7,175,496 (Lund et al.). The wings are supported by a central housing and have a lever assembly to operate the wings relative to the central housing.

U.S. Pat. No. 7,536,729 (Strauss et al.) is directed to a flexure element which may be covered by foam and covered by fabric to a 3-dimensional costume used under the costume. There are still other costumes in which foam elements are sewn into the costumes.

Some costumes have even gone high tech. There are costumes which include a small fan/air machine to “blow up” the costume to keep the costume inflated. There are other costumes which are illuminated with LED lighting as shown in U.S. Pat. Nos. 6,848,803 or 6,854,131 both issued to Spongberg. The lights can be of a simple design or all positioned all over the whole costume.

Thus there is a desire to be creative and to design new and different types of Halloween costumes.

### SUMMARY OF THE INVENTION

The invention relates to forming costumes, especially Halloween costumes from foam. The foam or layers of polymers are vacuum molded, and more specifically two sheets of plastic/polymers are vacuum molded at the same time to form the three-dimensional costume.

Typical names for these type of machines include vacuum forming machines, thermoforming machines, sheet fed vacuum formers, blister packaging machines, and many more.

The molded items formed with a standard molding machine are of a single sheet. To make a three dimensional item, two separate sheets would have to be individually formed and then sealed together (adhesive, or sewing have been used) before having the edges trimmed. Therefore, there is a need for a method to form three dimensional costume in one step.

A three-dimensional foam costume formed from a customized vacuum forming machine which has been altered to include two female molds. The machine also included a mechanism to separate the two mold such that in the open position, the two molds are separated by at least 30″. Two sheets of heated plastic are placed between the two molds and the machine is closed. Air is forced between the two plates to force the two sheets outward into each of the molds. Vacuum is then applied from outside the mold to remove trapped air between the plastic and the mold and to pull the material into or onto the mold complimenting the force of the pressurized air being forced between the sheets from the inside to form the plastic to match the detailed shape of the mold. The machine is opened and a sealed, three-dimensional costume is removed from the mold.

Vacuforming is a version of thermoforming whereby a sheet of plastic is heated to a forming temperature, stretched onto or into a single-surface mold, and held against the mold by applying vacuum between the mold surface and the sheet. The vacuum forming process can be used to make most product packaging, speaker casings and even car dashboards. Vacuum forming is usually, but not always restricted to forming plastic parts that are rather shallow in depth. A thin sheet is formed into rigid cavities for unit doses of pharmaceuticals and for loose objects that are carded or presented as point-of-purchase items. A thick sheet is formed into permanent objects such as turnpike signs and protective covers. Relatively deep parts can be formed if the form-able sheet is mechanically or pneumatically stretched prior to bringing it in contact with the mold surface and before vacuum is applied.

Thin-gauge thermoforming is primarily used for the manufacture of disposable cups, containers, lids, trays, blisters, clamshells, and other products for the food, medical, and general retail industries. Thick-gauge thermoforming includes the manufacturing of parts as diverse as vehicle doors and dash panels, refrigerator liners, utility vehicle beds, and plastic pallets.

Other thermoforming processes add the benefit of a mated mold (using both a male and female mold). In the most common method of high-volume, continuous thermoforming of thin-gauge products, a plastic sheet is fed from a roll or from an extruder into a set of indexing chains that incorporate pins, or spikes, that pierce the sheet and transport it through an oven for heating to forming temperature. The heated sheet then indexes into a form station where a mating mold (including a “male”: convex mold and “female”concave mold) and pressure-box closes on the sheet. Vacuum is then applied to remove trapped air and to pull the material into or onto the mold along with pressurized air to form the plastic to match the detailed shape of the mold. (Plug-assists are typically used in addition to vacuum in the case of taller, deeper-draw formed parts in order to provide the needed material distribution and thicknesses in the finished parts.) After a short form cycle, a burst of reverse air pressure is actuated from the vacuum side of the mold as the form tooling opens, commonly referred to as air-eject, to break the vacuum and assist the formed parts off of, or out of, the mold.

Heavy-gauge forming utilizes the same basic process as continuous thin-gauge sheet forming, typically draping the heated plastic sheet over a mold. Many heavy-gauge forming applications use vacuum only in the form process, although some use two halves of mating form tooling and include air pressure to help form the materials. Aircraft windscreens and machine gun turret windows spurred the advance of heavy-gauge forming technology during WWII. Heavy gauge parts are used as cosmetic surfaces on permanent structures such as automobiles, refrigerators, spas, and shower enclosures, and electrical and electronic equipment. Unlike most thin-gauge thermoformed parts, heavy-gauge parts are often hand-worked after forming for trimming to final shape or for additional drilling, cutting, or finishing, depending on the product. Heavy-gauge products typically are of a “permanent” end use nature, while thin-gauge parts are more often designed to be disposable or recyclable and are primarily used to package or contain a food item or product.

An object of the present invention is to provide a method of forming a three-dimensional highly detailed costume or a portion of a costume in one step using vacuum molding.

A further object is to provide a vacuum molding machine which includes two molds and which opens to at least 30″ in order to provide a three dimensional costume or portion thereof.

Advantageously, this reduces the tooling cost of prior art methods of manufacturing three dimensional costumes. This processes the three-dimensional costumes in one step reducing the cycle time in half as you form two halves simultaneously and also seal the halves without a secondary step or use of binding material.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is an illustration of a vacuum molding machine that includes two molds and that has been altered such that the plates can be separated by over 30″;

FIGS. 2A and 2B are an illustration of a vacuum molding machine in which air is being forced between the two sheets of plastic from inside the mold to push the plastic sheet outward against the mold and a close-up thereof;

FIG. 3 shows the vacuum holes allowing air to be drawn from outside the mold to pull plastic against mold;

FIGS. 4A-4C are illustrations of a three-dimensional costumes formed in the vacuum molding machine and close-ups thereof; and

FIGS. 5A-E illustrate alternative designs and views of various articles which can be produced using the method of this invention.

### DETAILED DESCRIPTION OF THE INVENTION

There is a desire to form light-weight, flexible, three-dimensional, polymeric costumes in a one step process. Previously this would have been accomplished using blow molding, roto molding or injection molding. These processes require expensive tooling at a cost in the 10's of thousands of dollars. It would have been difficult to form a relatively large and particularly flexible material costume using these methods (foam like consistency). An alternative method would be to form two separate halves of a three-dimensional costume and then seal the two halves together. The method described herein eliminates the necessity of forming two separate components, sealing the components together and then trimming the overlapping ends. A typical vacuum molding machine such as Bel-O-Vac 53″×103″ (135×262 cm) Manual Deep Draw Heavy Gage Vacuum Forming Machine obtained from Belo-O-Vac located at 1143 W. Lincoln St., Ste 11 Banning, Ca 92220-4527 Direct Line: 951-741-4822 Fax Number: 951-922-1494. belovac.com. includes a mold that thermoforms one sheet at a time. In order to make a three-dimensional costume, the vacuum molding machine required alterations to the machine.

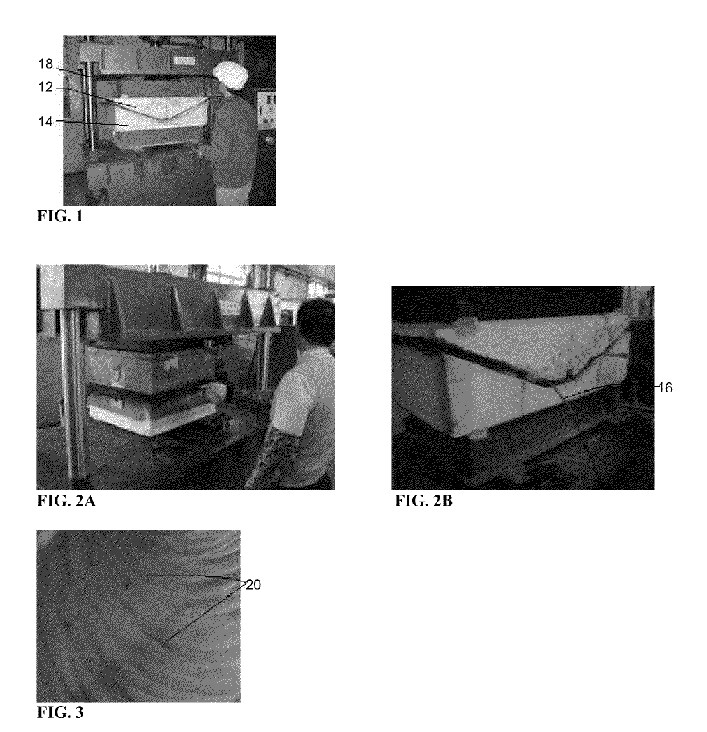

First instead of the vacuum molding machine 10 having one mold or if using a mated mold system (a male and female mold to create a mated mold) the stated system used two female molds were required, i.e. a top mold 12 and a bottom mold 14 as shown in FIG. 1. Also two sheets of plastic are placed in the mold instead of one and hence air (shown at 16) is required to be forced between the two sheets to force one sheet upward into the top mold and the other sheet downward into the bottom mold as shown in FIG. 2. During the sealing process, the molds are closed for about 80 to 125 seconds. This time may change depending on the materials being used.

Additionally, air will be drawn from outside of the mold through air holes 20 in the mold shown in FIG. 3 to draw the plastic back against the outside of the mold while the air being pushed into the mold between the sheets (shown at 16) so as to have both internal push and external draw on plastic against mold.

Since the desired end use is a three-dimensional dress-up costume, the circumference of this type of object is larger than the opening of a typical vacuum molding machine. Thus, the standard machine required modifications including adding extension bars 18 to allow the lift handle to be raised to over 30″ in circumference. This will allow the distance between the molds 12, 14 to be large enough to remove the completed three dimensional object.

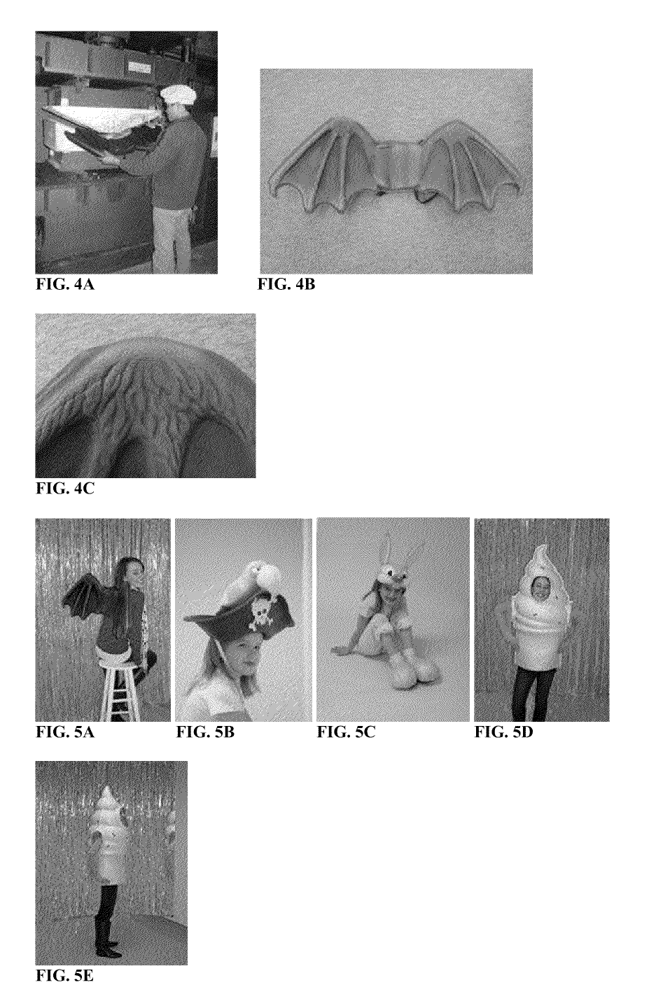

Two sheets of plastic are placed in between two female molds. These sheets are heated to the following specifications for current applications; however, the range of heat will vary with the material type and thickness and the size and depth of the mold. Air pressure is forced between the two sheets to force the sheets against the vacuum mold wall to maximize the detail on the outside of the three dimensional object. The two sheets are sealed together in the mold and thus do not require a separate sealing step as shown in FIG. 4. Once the three dimensional costume has been removed from the mold, it is allowed to cool. Depending on what the final costume looks like the costume may be cut. For example, holes may be cut for the body, head and arms. The formed items have memory and thus may be folded or squashed for shipping. Once removed from the shipping packaging, the items will return to their original formed shape. If the item is slightly crushed, the item may be heated with a heat source such as a hair drying and the plastic memory will return object to its original shape. As shown in FIGS. 4B and 5A the formed costume may only include a portion of a costume, like wings, or a hat as shown in FIG. 5B. There are many different varieties of costumes or portions thereof that may be formed.

The upper and lower sheets may be two different colors or may be preprinted.

When using this process to form wearable costumes, the selected material would have a starting size of about 24″ wide and then need to “blow up” or expand another 11-12″. Thus the material would have to have depth ratio of about 3/1 after expansion. A typical set of processing conditions for manufacturing 3D costumes include the following:

| | | | Other |
|---|---|---|---|
| | | Standard | Possible Conditions |
| Material | Ingredient | XLPE | XLPE + Additives/EVA |
| | Thickness | 3-12 mm | Deviation: ±2 mm |
| | No. of Expansion Time | 10x-30x | Extended Range: 3x-40x |
| Heating | Temperature | 180-200° C. | Deviation: ±50° C. |
| Process | Duration | 6-8 min | Deviation: ±3 min |
| Compression | Pressure | 50-70 Ton/sq. feet | Extended Range: 50-300 Ton/sq. feet |
| Process | Duration | 40-60 s | Deviation: ±15 s |
| Blowing | Pressure | 0.5-0.6 MPa | Deviation: ±0.2 MPa |
| Process | Duration | 10-15 s | Deviation: ±5 s |
| | Tube Opening | Dia: 8 mm | |
| Vacuum | Pressure | 0.5-0.6 MPa | Deviation: ±0.2 MPa |
| Process | Duration | 30-50 s | Deviation: ±10 s |
| Moldings | Material | Steel | Ceramic Mixture |
| | Size | | Min: 210 mm × 180 mm × 100 mm |
| | | | Max: 1150 mm × 700 mm × 260 mm |

Other materials that are typically used in vacuum molding machines may also be used. It is important that air can be blown between the two sheets such that the two sheets can be forced outward into the mold to ensure clear details are formed on both halves of the item. Also it is best to choose a material which has good sealing properties in the mold to avoid having to reinforce the seam, however this may be necessary. Additionally, the variety of materials capable of molding in this fashion is much broader than traditional thermoforming which is predominately High Impact Polystyrene Sheeting. This process even allows for materials such as low density polythalene to be first coated with fabric and then formed. Although the present invention has been shown and described with respect to several preferred embodiments thereof, various changes, omissions and additions to the form and detail thereof, may be made therein, without departing from the spirit and scope of the invention.

What is claimed is:

1. A vacuum molding or thermoforming machine to simultaneously mold two sheets of plastic into a costume; said machine comprising
two female concave molds which are positioned one over the other;
an opening mechanism to open and close the two molds;
positions to accept two sheets of plastic;
means to provide air pressure between two sheets of plastic to force each sheet into one of the molds to form a three-dimensional costume and wherein the edges of the costume are sealed.

2. The vacuum molding or thermoforming machine of claim 1, wherein the machine includes means to provide vacuum pressure from outside of the mold to draw air through the mold and pull sheet up against mold creating fine detail.

3. The vacuum molding or thermoforming machine of claim 1, such that when the machine is in an open position, the two molds are at least 30 inches apart.

4. A method of forming a three dimensional costume, said method comprising:
placing two molds in a vacuum molding machine which is operable between and open position and a closed position,
placing two sheets of plastic in the machining;
forcing air between the two sheets to force the sheets into the molds;
drawing air from outside the mold creating a vacuum to pull sheet against mold;
optionally reversing air on outside of mold once molding is complete to push plastic away from mold to release plastic from mold and make removal easier; and
removing the three-dimensional costume from the mold such that the edges are sealed.

5. The method of claim 4, wherein the molds are closed for about 80 to 125 seconds to form and seal and create the three-dimensional costume.

6. The method of claim 4, wherein an item is placed between the two sheets of plastic and sealed therein.
